(19) United States
(12) Patent Application Publication
(10) Pub. No.: US 2026/0178105 A1
(43) Pub. Date: Jun. 25, 2026

(54) OPTIMIZING DEEP SLEEP ENTRY TIME ON HYPERVISOR -SUPPORTED PLATFORMS

(71) Applicant: QUALCOMM Incorporated, San Diego, CA (US)

(72) Inventors: Swapnil Kailas KAUTHALE, Hyderabad (IN); Kartikey SINGH, New Delhi (IN); Sanjay RAMAGIRI, Hyderabad (IN); Sameer SAURABH, Mau (IN)

(21) Appl. No.: 18/988,755

(22) Filed: Dec. 19, 2024

(51) Int. Cl. G06F 1/3287; G06F 11/14

(52) U.S. Cl. CPC G06F 1/3287; G06F 11/1446

(57) ABSTRACT

A computing system is provided with an enhanced entry to a deep sleep mode. The enhanced entry occurs after an initial deep sleep mode before which the computing system backed up an entirety of a configuration context to a configuration context buffer in a system memory. After the initial deep sleep mode, the computing system updates the configuration context buffer with any changes made to the configuration context. Since the configuration context stored in the configuration context buffer is thus in sync with the actual configuration context, a subsequent entry to a deep sleep state may be performed without any updating of the configuration context buffer.

### TECHNICAL FIELD

The present application relates generally to a hypervisor-supported computing systems, and more particularly to hypervisor-supported computing system with optimized deep sleep entry time.

### BACKGROUND

System-on-a-chip (SoC) devices may include one or more processors, coupled through a bus to one or more client devices (e.g., input/output devices). It is convenient for the client devices to address a system memory such as a double data rate (DDR) dynamic random-access memory (DRAM) without the memory access passing through the processor(s) in what is denoted as a direct memory access. A system memory management unit (SMMU) assists in this direct memory access (DMA) by translating virtual addresses for DMA from the client devices into physical addresses for addressing the DDR DRAM. An SMMU is configured to perform this translation using memory-mapped configuration registers that define how the virtual-to-physical address translation should occur and also manage the access control.

To reduce power consumption, an SoC with client devices running as virtual devices may transition into a deep sleep state in which the contents of clients'configuration registers is lost. This lost data may be denoted as the configuration context or context bank for a corresponding virtual machine/client device. Prior to the entry into a deep sleep state (which may also be denoted as a deep sleep mode), a hypervisor for the virtual machines manages the back up of their configuration context in the DDR DRAM. An SMMU will typically have multiple context banks, with each context bank being assigned to a corresponding client device or address space. To configure the context banks, the configuration registers point to page tables for address translation for a given context bank and also define various permissions and attributes. There are a variety of other configuration registers such as for configuring the translation lookaside buffer (TLB), managing interrupts and faults, and so on.

It may thus be appreciated that the configuration register space or storage is relatively large. At power-up of the system, the SMMU performs an initialization procedure in which the configuration registers are either reset or set to some default configuration. During subsequent operation, the configuration registers then store the SMMU context that is developed as the client devices perform SMMU transactions with the main memory. Should the system then enter a deep sleep state or perform a quick boot, the SMMU context should then be saved in the main memory such as the DDR DRAM so that the SMMU context may be restored when the system reboots or leaves the deep sleep state. But traditional hypervisor-supported systems cannot identify whether a configuration register has been changed during normal operation. It is thus conventional to back up the entire configuration register space prior to entering a deep sleep state or a quick boot by writing the contents of the configuration registers to the main memory. But the large configuration register space causes the resulting backup of the SMMU context to consume an appreciable amount of time, which slows system operation by delaying the transition to a non-retention state for the configuration registers. The delay also increases power consumption. A similar delay occurs upon the restoration of the SMMU context following a termination of the non-retention state and a resumption of normal operation.

### SUMMARY

In accordance with an aspect of the disclosure, a method of enhanced deep sleep entry for a computing system including a system memory management unit (SMMU) and a system memory is provided that includes: backing up a first stored content of a first plurality of configuration registers for the SMMU by writing the first stored content to an SMMU backup buffer in the system memory before entering a first deep sleep state for the computing system in which the first plurality of configuration registers is powered down; responding to a first change in a configuration context for the SMMU during an active state for the computing system following the first deep sleep state by updating the SMMU backup buffer with the first change in the configuration context for the SMMU; and entering a second deep sleep state for the computing system in which the first plurality of configuration registers is powered down without a backup of the first stored content to the SMMU backup buffer.

In accordance with another aspect of the disclosure, a computing system is provided having an at least one processor that is configured to: back up a first stored content of a first plurality of configuration registers for an SMMU through a write of the first stored content to an SMMU backup buffer in a system memory before an entry to a first deep sleep state in which the first plurality of configuration registers is powered down; respond to a first change in a configuration context for the SMMU during an active state for the computing system following the first deep sleep state with an update of the SMMU backup buffer with the first change in the configuration context for the SMMU; and enter a second deep sleep state in which the first plurality of configuration registers is powered down without a backup of the first stored content to the SMMU backup buffer.

Finally, in accordance with yet another aspect of the disclosure, a computer-readable medium is provided that includes instructions that when executed by a computing system cause the computing system to: back up a first stored content of a first plurality of configuration registers for an SMMU through a write of the first stored content to an SMMU backup buffer in a system memory before an entry to a first deep sleep state in which the first plurality of configuration registers is powered down; respond to a first change in a configuration context for the SMMU during an active state following the first deep sleep state through an update to the SMMU backup buffer with the first change in the configuration context for the SMMU; and enter a second deep sleep state in which the first plurality of configuration registers is powered down without a backup of the first stored content to the SMMU backup buffer.

These and other advantageous features may be better appreciated through the following detailed description.

### BRIEF DESCRIPTION OF THE DRAWINGS

FIG. 1 illustrates a process flow for a traditional deep sleep entry.

FIG. 2 illustrates a computer system configured for an enhanced deep sleep entry in accordance with an aspect of the disclosure.

FIG. 3 illustrates a process flow for an enhanced deep sleep entry in accordance with an aspect of the disclosure.

FIG. 4 illustrates an example computer system that is configured to practice enhanced deep sleep entry disclosed herein in accordance with an aspect of the disclosure.

FIG. 5 is a flowchart for an example method of performing an enhanced deep sleep entry in accordance with an aspect of the disclosure.

Implementations of the present disclosure and their advantages are best understood by referring to the detailed description that follows. It should be appreciated that like reference numerals are used to identify like elements illustrated in one or more of the figures.

### DETAILED DESCRIPTION

During a deep sleep state, the client devices need an ability to respond to interrupts to then resume normal operation. A computing system may thus include a watchdog (WDOG) for each peripheral device to monitor whether the peripheral device should transition from the deep sleep mode back to normal operation. A configuration context for the watchdog is stored in a corresponding configuration register space. During normal operation, a peripheral device may issue an interrupt that is directed to a corresponding processor core. A generic interrupt controller (GIC) hardware for the peripheral devices receives the interrupts, prioritizes them as necessary, and transmits them to the appropriate processor core. A configuration context for the GIC is thus also stored in a corresponding configuration register space. Just like the SMMU configuration register space, the hypervisor virtualizes the configuration context storage for the GIC and the WDOG. At a deep sleep entry, the hypervisor in a traditional computing system manages a backup of the entire SMMU, GIC, and WDOG context in the DDR DRAM. Backing up the entire configuration context introduces significant latency in the transition to a deep sleep state.

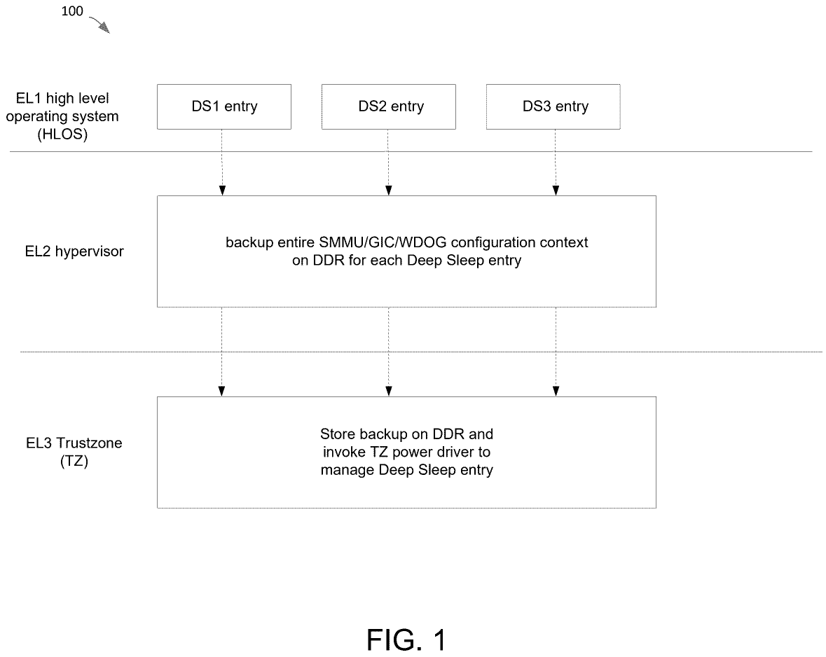

This latency may be better appreciated through a consideration of the process flow 100 shown in FIG. 1 for a traditional deep sleep entry. The client devices (not shown) operate through high level operating systems (HLOS) in a privilege level denoted as an exception level 1 (EL1 ). Following a boot up of the SoC, the SoC may enter a deep sleep state multiple times such as a first deep sleep entry (DS1 entry) followed by a second deep sleep entry (DS2 entry) that in turn is followed by a third deep sleep entry (DS3 entry). For each deep sleep entry, a hypervisor operating on an exception level 2 (EL2 ) manages a backup on DDR DRAM of the entire SMMU/GIC/WDOG configuration context. The SoC stores the configuration context to the DDR DRAM as managed in an exception level 3 (EL3 ). The DDR DRAM is maintained as part of a secure TrustZone (TZ) for the SoC. Due to the relatively large size of the configuration context, storing the entire configuration backup onto the DDR DRAM introduces considerable latency.

The latency resulting from the backup of the entire configuration context is then repeated for each deep sleep entry. Although the entire configuration context must be retained, note that many of the configuration registers are not modified from one deep sleep cycle to the next. For example, many configuration registers that were initialized at bootup of the SoC will not have their stored data modified, regardless of how many deep sleep cycles ensue from the bootup. Similarly, stage 2 configuration registers (e.g., stream mapping registers (SMR), configuration base registers (CBAR), and translation table base registers (TTBR) are generally programmed only once at bootup and never updated until the target is running.

A computing system such as an SoC is disclosed herein that alleviates the deep sleep latency entry problem by updating a system memory backup buffer with any changes to the configuration context after an initial deep sleep entry following an initialization of the configuration registers at boot up of the computing system. The following discussion will be directed to an SoC implementation of the computing system, but it will be appreciated that any suitable computing system may be adapted to perform the optimized deep sleep entry disclosed herein. At the initial deep sleep entry, the entire configuration context is stored in the DDR DRAM (for brevity, the DDR DRAM will be referred to simply as the DDR in the following discussion). For this storage, the DDR includes a backup buffer for the SMMU, the GIC, and the WDOG. At a boot up from each deep sleep entry, the hypervisor traps any modifications to the configuration registers. A virtualization handler may then update the DDR backup buffers for the modified configuration registers with the changes that were trapped by the hypervisor to the modified configuration registers. Should the SoC then transition again to the deep sleep state, there is no need to perform any backup operation as the DDR backup buffers are in sync with the changed configuration context.

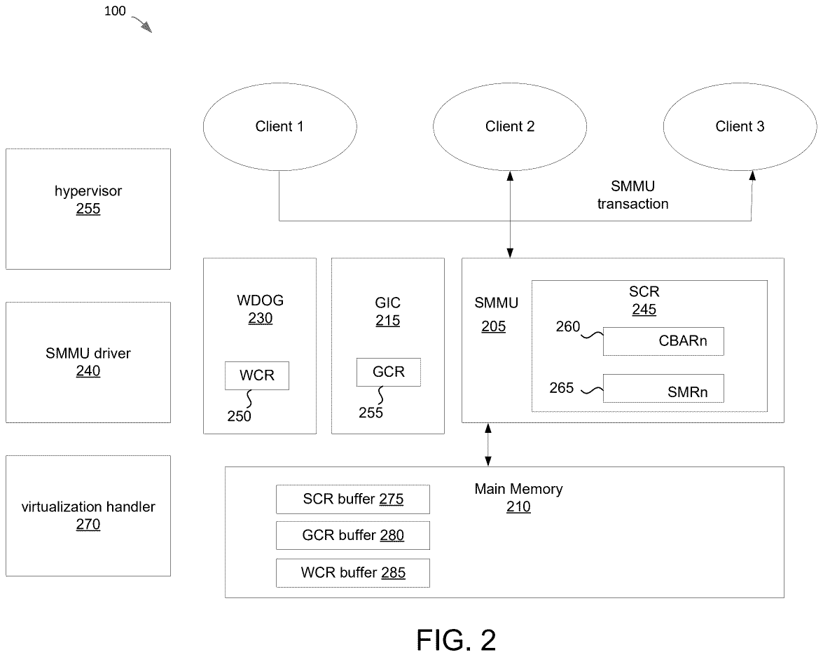

An example SoC 200 with an optimized deep sleep entry is shown in FIG. 2. A plurality of client devices (e.g., a Client 1, a Client 2, and a Client 3) have their direct memory access to a main memory (e.g., a DDR 210) managed by an SMMU 205. At an initialization of the SMMU 205 such as at power-up of the SoC 200, an SMMU driver 250 initializes an entire SMMU configuration register (SCR) space 245 for the SMMU 205. During an active mode for the clients, a GIC 215 manages interrupts from the client devices. The GIC 215 is configured through a GIC configuration register (GCR) space 250. Similarly, a WDOG 230 is configured through a WDOG configuration register (WCR) space 255. A hypervisor 255 manages the virtualization of the client devices, the WDOG 230, the GIC 215, and the SMMU 205.

After a first active mode following an initialization of the configuration register spaces 245, 250, and 255, the SoC 200 enters a first deep sleep mode. A virtualization handler 270 writes the entire SCR 245 to a SCR buffer 275 in the DDR 210. Similarly, the virtualization handler 270 writes the entire GCR 255 to a GCR buffer 280 in the DDR 210 and writes the entire WCR 250 to a WCR buffer 285 in the DDR 210. Upon reentry from the initial deep sleep, the hypervisor 255 manages the restoration of the configuration context for the SMMU 205 through a write of the contents of the SCR buffer 275 to the SCR 245, a write of the contents of the GCR buffer 280 to the GCR 255, and also a write of the contents of the WCR buffer 285 to the WCR 250. With the configuration context restored, the SoC 200 may resume normal operation.

During a second active mode for the SoC 200 following the initial deep sleep, one of the client devices may engage in a transaction with the SMMU 205 that changes the configuration context stored in the SCR space 245 for the SMMU 205. This change in the SMMU configuration context may occur with respect to an nth context bank as managed by a corresponding nth context bank address register CBARn 260, where n is a positive integer identifying the corresponding context bank for the SMMU transaction. Similarly, the SMMU transaction may also change the contents of a nth stream ID register SMRn 265, where the nth stream ID relates to the address translation context for the SMMU transaction. To flag this change in the SMMU configuration context following an initial deep sleep state, the hypervisor 255 traps the execution of the write to the SCR space 245 and commands the virtualization handler 270 to update the SCR buffer 275 with the changes. Similarly, the hypervisor 255 monitors any changes to the watchdog configuration context by trapping write commands to the WCR 250 and commanding the virtualization handler 270 to update the WCR buffer 285 with the changes. In the same fashion, the hypervisor 255 monitors any changes to the GIC configuration context by trapping write commands to the GCR 255 and commanding the virtualization handler 270 to update the GCR buffer 280 with the changes. Since the buffered configuration context stored in the DDR 210 is always up to date with any changes to the configuration context stored in the configuration registers, an entry to a subsequent deep sleep state (e.g., a second deep sleep state, a third deep sleep state, and so on) does not require any updates to the buffers 275, 280, and 285. The transition latency to the subsequent deep sleep states is thus substantially reduced.

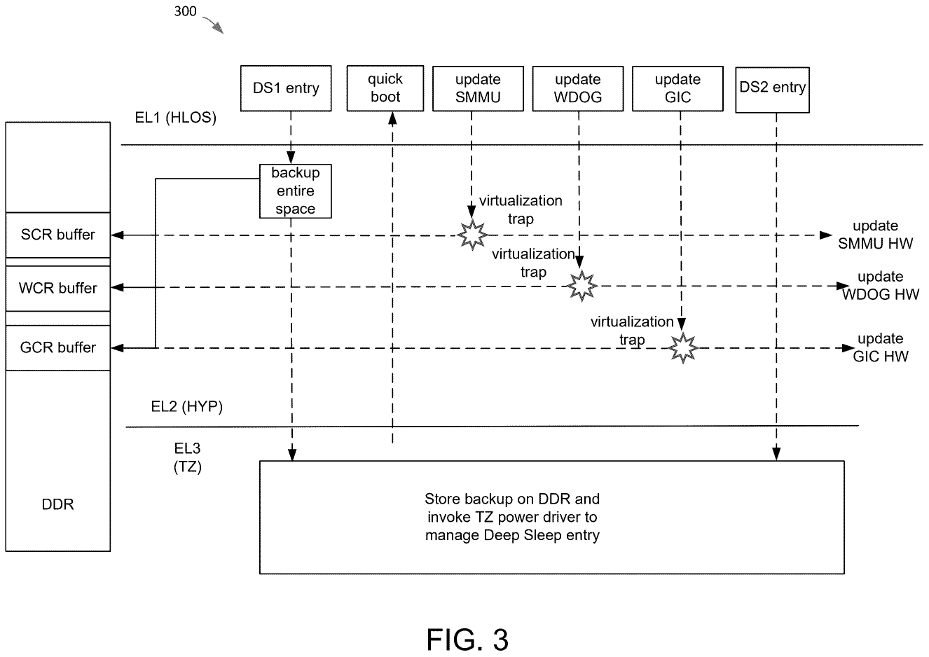

An example process flow 300 for a computing system with an enhanced deep sleep state entry is shown in FIG. 3. At an initial or first entry (DS1 entry) to the deep sleep state, a backup of the entire configuration context for the SMMU, GIC, and the WDOG is performed. The DS1 entry is initiated at the device level at the exception level 1 (EL1 ) with the backup of the configuration context being managed by the hypervisor (HYP) at the exception level 2 (EL2 ). The SCR backup buffer, the WCR backup buffer, and the GCR backup buffer in the DDR are thus written to accordingly. The deep sleep entry is managed by a TrustZone (TZ) power driver at the exception level 3 (EL3 ). After a quick boot, the SMMU configuration context may be changed, which triggers a virtualization trap by the hypervisor to in turn force an update to the SCR buffer of the SMMU configuration context change. The update in the SMMU configuration context also updates the SMMU hardware (HW). Similarly, the watchdog configuration context may be changed, which triggers a virtualization trap to in turn force an update to the WCR buffer of the WDOG configuration context change. The update in the watchdog configuration context causes an update of the watchdog HW. In the same fashion, the GIC configuration context may be changed, which triggers a virtualization trap to in turn force an update to the GCR buffer of the configuration context change. The update in the GIC configuration context causes an update of the GIC HW.

Since the buffered configuration context in the DDR is consistent with the configuration context in the configuration registers for the SMMU, GIC, and WDOG, a subsequent second entry to a deep sleep state (DS2 entry) occurs without any updating of the SCR, WCR, and GCR backup buffers. It will be appreciated that the trapping of any configuration context changes to the SMMU, WDOG, and GIC and corresponding updates of the backup buffers may be continued following a third deep sleep entry, a fourth deep sleep entry, and so on. Each deep sleep entry subsequent to the initial deep sleep entry may thus be performed without any further updates to the backup buffers in the DDR.

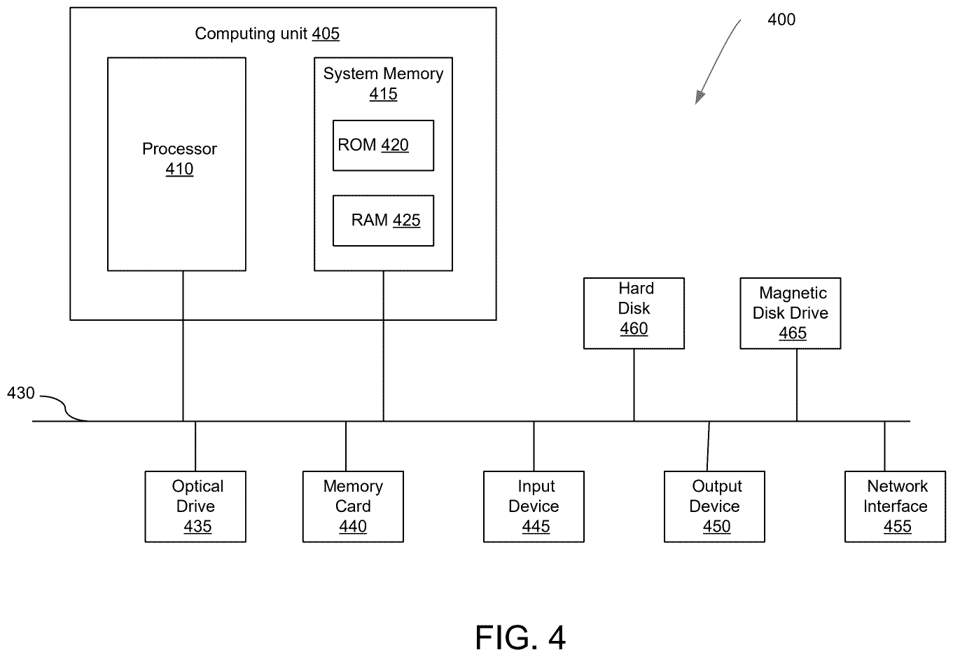

Any suitable computing system may be used to implement the enhanced deep sleep entry disclosed herein. An example computing system 400 that may be programmed to implement the SMMU/WDOG/GIC configuration context save and enhanced deep sleep entry is shown in FIG. 4. As seen in this figure, the computing system 400 includes a computing unit 405 with an at least one processor 410 that executes instructions from and stores data in a system memory 415. The at least one processor 410 may be any type of programmable electronic device for executing software instructions but will typically be one or more microprocessors. The system memory 415 may include both a read-only memory (ROM) 420 and a random-access memory (RAM) 425. As will be appreciated by those of ordinary skill in the art, both the read-only memory (ROM) 420 and the random-access memory (RAM) 425 may store software instructions for execution by the at least one processor 410.

The at least one processor 410 and the system memory 415 are connected, either directly or indirectly, through a bus 430 or alternate communication structure, to one or more peripheral devices. For example, the at least one processor 410 or the system memory 415 may be directly or indirectly connected to one or more additional memory storage devices, such as a “hard” magnetic disk drive 460, a removable magnetic disk drive 465, an optical disk drive 435, or a flash memory card 440. The at least one processor 410 and the system memory 415 also may be directly or indirectly connected to one or more input devices 445 and one or more output devices 450. The input devices 445 may include, for example, a keyboard, a pointing device (such as a mouse, touchpad, stylus, trackball, or joystick), a scanner, a camera, and a microphone. The output devices 445 may include, for example, a monitor display, a printer and speakers. With various examples of the computer system 400, one or more of the peripheral devices 435, 440, 445, 460, and 465 may be internally housed within a housing of the computer system 400. Alternately, one or more of the peripheral devices 435, 440, 445, 460, and 465 may be external to the housing and connected to the bus 430 through, for example, a Universal Serial Bus (USB) connection.

With some implementations, the computing system 400 may be directly or indirectly connected to one or more network interfaces 455 for communicating with other devices making up a network. The network interface 455 translates data and control signals from the computer system 400 into network messages according to one or more communication protocols, such as the transmission control protocol (TCP) and the Internet protocol (IP). Also, the interface 455 may employ any suitable connection agent (or combination of agents) for connecting to a network, including, for example, a wireless transceiver, a modem, or an Ethernet connection. Such network interfaces and protocols are well known in the art, and thus will not be discussed here in more detail. It should be appreciated that the computing system 400 is illustrated as an example only, and it not intended to be limiting. Various implementations may be formed using one or more computing systems that include the components of the system 400 illustrated in FIG. 4 or which include only a subset of the components illustrated in FIG. 4, or which include an alternate combination of components, including components that are not shown in FIG. 4.

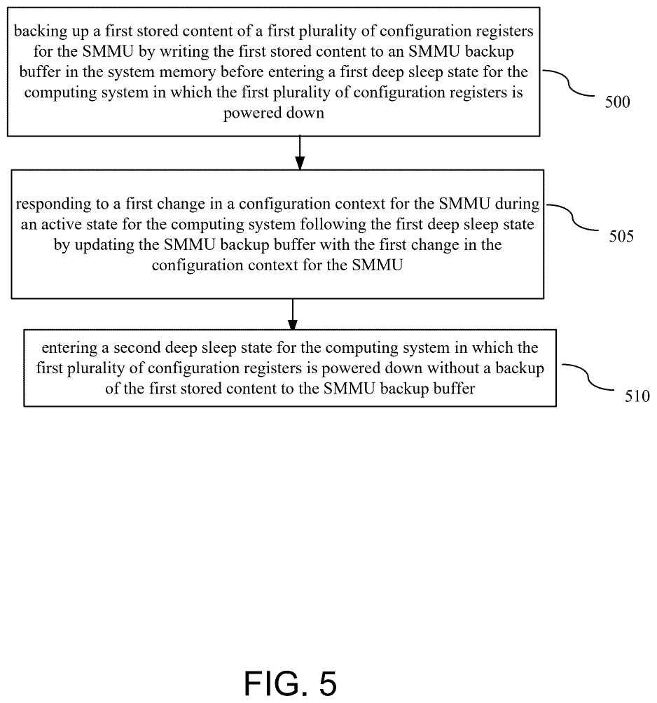

A method of enhanced deep sleep entry will now be discussed with respect to the flowchart of FIG. 5. The method includes an act 500 of backing up a first stored content of a first plurality of configuration registers for the SMMU by writing the first stored content to an SMMU backup buffer in the system memory before entering a first deep sleep state for the computing system in which the first plurality of configuration registers is powered down. The backing up of the configuration register space 245 in system 200 of is an example of act 500. The method further includes an act 505 of responding to a first change in a configuration context for the SMMU during an active state for the computing system following the first deep sleep state by updating the SMMU backup buffer with the first change in the configuration context for the SMMU. The update to the SCR buffer 275 following the first deep sleep state in response to a change in the configuration context is an example of act 505. Finally, the method includes an act 510 of entering a second deep sleep state for the computing system in which the first plurality of configuration registers is powered down without a backup of the first stored content to the SMMU backup buffer. The entering of the second deep sleep state as discussed with regard to the process flow 300 is an example of act 510.

Some example implementations will now be summarized through the following numbered clauses:

Clause 1. A method of enhanced deep sleep entry for a computing system including a system memory management unit (SMMU) and a system memory, comprising:
backing up a first stored content of a first plurality of configuration registers for the SMMU by writing the first stored content to an SMMU backup buffer in the system memory before entering a first deep sleep state for the computing system in which the first plurality of configuration registers is powered down;
responding to a first change in a configuration context for the SMMU during an active state for the computing system following the first deep sleep state by updating the SMMU backup buffer with the first change in the configuration context for the SMMU; and
entering a second deep sleep state for the computing system in which the first plurality of configuration registers is powered down without a backup of the first stored content to the SMMU backup buffer.

Clause 2. The method of clause 1, wherein the first stored content comprises an entirety of the configuration context for the SMMU.

Clause 3. The method of any of clauses 1-2, wherein responding to the first change in the configuration context for the SMMU comprises performing a first virtualization trap in a hypervisor for the computing system.
Clause 4. The method of any of clauses 1-3, further comprising:
responding to a second change in the configuration context for the SMMU during an active state for the computing system following the second deep sleep state by updating the SMMU backup buffer with the second change in the configuration context for the SMMU; and
entering a second deep sleep state for the computing system in which the first plurality of configuration registers is powered down without a backup of the first stored content to the SMMU backup buffer.

Clause 5. The method of clause 3, further comprising:
backing up a second stored content of a second plurality of configuration registers for a generic interrupt controller (GIC) of the computing system by writing the second stored content to a GIC backup buffer in the system memory before entering the first deep sleep state; and
responding to a first change in a configuration context for the GIC during the active state for the computing system following the first deep sleep state by updating the GIC backup buffer with the first change in the configuration context for the GIC, wherein the entering of the second deep sleep state is performed without a backup of the second stored content to the GIC backup buffer.

Clause 6. The method of clause 5, wherein the second stored content comprises an entirety of the configuration context for the GIC.

Clause 7. The method of clause 5, wherein responding to the first change in the configuration context for the GIC comprises performing a second virtualization trap in the hypervisor for the computing system.

Clause 8. The method of clause 5, further comprising:
backing up a third stored content of a third plurality of configuration registers for a watchdog (WDOG) of the computing system by writing the third stored content to a WDOG backup buffer in the system memory before entering the first deep sleep state; and
responding to a first change in a configuration context for the WDOG during the active state for the computing system following the first deep sleep state by updating the WDOG backup buffer with the first change in the configuration context for the WDOG, wherein the entering of the second deep sleep state is performed without a backup of the third stored content to the WDOG backup buffer.

Clause 9. The method of clause 8, wherein the third stored content comprises an entirety of a configuration context for the WDOG.

Clause 10. The method of any of clauses 8-9, wherein responding to the first change in the configuration context for the WDOG comprises performing a third virtualization trap in the hypervisor for the computing system.

Clause 11. The method of any of clauses 1-10, wherein the computing system comprises a system-on-a-chip.

Clause 12. A computing system having an at least one processor that is configured to:
back up a first stored content of a first plurality of configuration registers for an SMMU through a write of the first stored content to an SMMU backup buffer in a system memory before an entry to a first deep sleep state in which the first plurality of configuration registers is powered down;
respond to a first change in a configuration context for the SMMU during an active state for the computing system following the first deep sleep state with an update of the SMMU backup buffer with the first change in the configuration context for the SMMU; and
enter a second deep sleep state in which the first plurality of configuration registers is powered down without a backup of the first stored content to the SMMU backup buffer.

Clause 13. The computing system of clause 12, wherein the first stored content comprises an entirety of the configuration context for the SMMU.

Clause 14. The computing system of any of clauses 12-13, wherein the at least one processor is further configured to:
respond to a second change in the configuration context for the SMMU during an active state following the second deep sleep state with an update of the SMMU backup buffer with the second change in the configuration context for the SMMU; and
enter a second deep sleep state in which the first plurality of configuration registers is powered down without a backup of the first stored content to the SMMU backup buffer.

Clause 15. The computing system of claim of any of clauses 12-14, wherein the at least one processor is further configured to:
back up a second stored content of a second plurality of configuration registers for a generic interrupt controller (GIC) through a write of the second stored content to a GIC backup buffer in the system memory before the entry to the first deep sleep state; and
respond to a first change in a configuration context for the GIC during the active state following the first deep sleep state with an update to the GIC backup buffer with the first change in the configuration context for the GIC, wherein the entry to the second deep sleep state is performed without a backup of the second stored content to the GIC backup buffer.

Clause 16. the computing system of clauses 12-15, wherein the at least one processor is further configured to:
back up a third stored content of a third plurality of configuration registers for a watchdog (WDOG) through a write of the third stored content to a WDOG backup buffer in the system memory before the entry to the first deep sleep state; and
respond to a first change in a configuration context for the WDOG during the active state for the computing system following the first deep sleep state through an update to the WDOG backup buffer with the first change in the configuration context for the WDOG, wherein the entry to the second deep sleep state is performed without a backup of the third stored content to the WDOG backup buffer.

Clause 17. A computer-readable medium including instructions that when executed by a computing system cause the computing system to:
back up a first stored content of a first plurality of configuration registers for an SMMU through a write of the first stored content to an SMMU backup buffer in a system memory before an entry to a first deep sleep state in which the first plurality of configuration registers is powered down;
respond to a first change in a configuration context for the SMMU during an active state following the first deep sleep state through an update to the SMMU backup buffer with the first change in the configuration context for the SMMU; and
enter a second deep sleep state in which the first plurality of configuration registers is powered down without a backup of the first stored content to the SMMU backup buffer.

Clause 18. The computer-readable medium of clause 17, wherein the first stored content comprises an entirety of the configuration context for the SMMU.

Clause 19. The computer-readable medium of any of clauses 17-18, wherein responding to the first change in the configuration context for the SMMU comprises performing a first virtualization trap in a hypervisor for the computing system.

Clause 20. The computer-readable medium of any of clauses 17-19, wherein the instructions are further executable to cause the computing system to:
respond to a second change in the configuration context for the SMMU during an active state for the computing system following the second deep sleep state through an update to the SMMU backup buffer with the second change in the configuration context for the SMMU; and
enter a second deep sleep state in which the first plurality of configuration registers is powered down without a backup of the first stored content to the SMMU backup buffer.

As those of some skill in this art will by now appreciate and depending on the particular application at hand, many modifications, substitutions and variations can be made in and to the materials, apparatus, configurations and methods of use of the devices of the present disclosure without departing from the scope thereof as defined by the appended claims. In light of this, the scope of the present disclosure should not be limited to that of the particular implementations illustrated and described herein, as they are merely by way of some examples thereof, but rather, should be fully commensurate with that of the claims appended hereafter and their functional equivalents.

What is claimed is:

1. A method of enhanced deep sleep entry for a computing system including a system memory management unit (SMMU) and a system memory, comprising:
backing up a first stored content of a first plurality of configuration registers for the SMMU by writing the first stored content to an SMMU backup buffer in the system memory before entering a first deep sleep state for the computing system in which the first plurality of configuration registers is powered down;
responding to a first change in a configuration context for the SMMU during an active state for the computing system following the first deep sleep state by updating the SMMU backup buffer with the first change in the configuration context for the SMMU; and
entering a second deep sleep state for the computing system in which the first plurality of configuration registers is powered down without a backup of the first stored content to the SMMU backup buffer.

2. The method of claim 1, wherein the first stored content comprises an entirety of the configuration context for the SMMU.

3. The method of claim 1, wherein responding to the first change in the configuration context for the SMMU comprises performing a first virtualization trap in a hypervisor for the computing system.

4. The method of claim 1, further comprising:
responding to a second change in the configuration context for the SMMU during an active state for the computing system following the second deep sleep state by updating the SMMU backup buffer with the second change in the configuration context for the SMMU; and
entering a second deep sleep state for the computing system in which the first plurality of configuration registers is powered down without a backup of the first stored content to the SMMU backup buffer.

5. The method of claim 3, further comprising:
backing up a second stored content of a second plurality of configuration registers for a generic interrupt controller (GIC) of the computing system by writing the second stored content to a GIC backup buffer in the system memory before entering the first deep sleep state; and
responding to a first change in a configuration context for the GIC during the active state for the computing system following the first deep sleep state by updating the GIC backup buffer with the first change in the configuration context for the GIC, wherein the entering of the second deep sleep state is performed without a backup of the second stored content to the GIC backup buffer.

6. The method of claim 5, wherein the second stored content comprises an entirety of the configuration context for the GIC.

7. The method of claim 5, wherein responding to the first change in the configuration context for the GIC comprises performing a second virtualization trap in the hypervisor for the computing system.

8. The method of claim 5, further comprising:
backing up a third stored content of a third plurality of configuration registers for a watchdog (WDOG) of the computing system by writing the third stored content to a WDOG backup buffer in the system memory before entering the first deep sleep state; and
responding to a first change in a configuration context for the WDOG during the active state for the computing system following the first deep sleep state by updating the WDOG backup buffer with the first change in the configuration context for the WDOG, wherein the entering of the second deep sleep state is performed without a backup of the third stored content to the WDOG backup buffer.

9. The method of claim 8, wherein the third stored content comprises an entirety of a configuration context for the WDOG.

10. The method of claim 8, wherein responding to the first change in the configuration context for the WDOG comprises performing a third virtualization trap in the hypervisor for the computing system.

11. The method of claim 1, wherein the computing system comprises a system-on-a-chip.

12. A computing system having an at least one processor that is configured to:
back up a first stored content of a first plurality of configuration registers for an SMMU through a write of the first stored content to an SMMU backup buffer in a system memory before an entry to a first deep sleep state in which the first plurality of configuration registers is powered down;
respond to a first change in a configuration context for the SMMU during an active state for the computing system following the first deep sleep state with an update of the SMMU backup buffer with the first change in the configuration context for the SMMU; and
enter a second deep sleep state in which the first plurality of configuration registers is powered down without a backup of the first stored content to the SMMU backup buffer.

13. The computing system of claim 12, wherein the first stored content comprises an entirety of the configuration context for the SMMU.

14. The computing system of claim 12, wherein the at least one processor is further configured to:
respond to a second change in the configuration context for the SMMU during an active state following the second deep sleep state with an update of the SMMU backup buffer with the second change in the configuration context for the SMMU; and
enter a second deep sleep state in which the first plurality of configuration registers is powered down without a backup of the first stored content to the SMMU backup buffer.

15. The computing system of claim 12, wherein the at least one processor is further configured to:
back up a second stored content of a second plurality of configuration registers for a generic interrupt controller (GIC) through a write of the second stored content to a GIC backup buffer in the system memory before the entry to the first deep sleep state; and
respond to a first change in a configuration context for the GIC during the active state following the first deep sleep state with an update to the GIC backup buffer with the first change in the configuration context for the GIC, wherein the entry to the second deep sleep state is performed without a backup of the second stored content to the GIC backup buffer.

16. The computing system of claim 12, wherein the at least one processor is further configured to:
back up a third stored content of a third plurality of configuration registers for a watchdog (WDOG) through a write of the third stored content to a WDOG backup buffer in the system memory before the entry to the first deep sleep state; and
respond to a first change in a configuration context for the WDOG during the active state for the computing system following the first deep sleep state through an update to the WDOG backup buffer with the first change in the configuration context for the WDOG, wherein the entry to the second deep sleep state is performed without a backup of the third stored content to the WDOG backup buffer.

17. A computer-readable medium including instructions that when executed by a computing system cause the computing system to:
back up a first stored content of a first plurality of configuration registers for an SMMU through a write of the first stored content to an SMMU backup buffer in a system memory before an entry to a first deep sleep state in which the first plurality of configuration registers is powered down;
respond to a first change in a configuration context for the SMMU during an active state following the first deep sleep state through an update to the SMMU backup buffer with the first change in the configuration context for the SMMU; and
enter a second deep sleep state in which the first plurality of configuration registers is powered down without a backup of the first stored content to the SMMU backup buffer.

18. The computer-readable medium of claim 17, wherein the first stored content comprises an entirety of the configuration context for the SMMU.

19. The computer-readable medium of claim 17, wherein responding to the first change in the configuration context for the SMMU comprises performing a first virtualization trap in a hypervisor for the computing system.

20. The computer-readable medium of claim 17, wherein the instructions are further executable to cause the computing system to:
respond to a second change in the configuration context for the SMMU during an active state for the computing system following the second deep sleep state through an update to the SMMU backup buffer with the second change in the configuration context for the SMMU; and
enter a second deep sleep state in which the first plurality of configuration registers is powered down without a backup of the first stored content to the SMMU backup buffer.
